(19) United States
(12) Patent Application Publication
(10) Pub. No.: US 2017/0115143 A1
(43) Pub. Date: Apr. 27, 2017

(54) EXAMINATION PROCESS FOR THE IN SITU DETERMINATION OF RATE OF FEEDING AN INHIBITOR INTO A GAS PIPELINE FOR PREVENTING HYDRATE FORMATION

(71) Applicant: Pal Farkas, Totkomlos (HU)

(72) Inventor: Pal Farkas, Totkomlos (HU)

(21) Appl. No.: 14/919,060

(22) Filed: Oct. 21, 2015

(51) Int. Cl. G01F 1/34

(52) U.S. Cl. CPC G01F 1/34

(57) ABSTRACT

The invention relates to an examination process for the in situ determination of rate of feeding an inhibitor into a gas pipeline for preventing hydrate formation comprising the steps of:
taking gas in situ from a gas well through a gas pipeline having an inlet,
feeding the inhibitor into the gas pipeline,
carrying the gas comprising the inhibitor to a coolable portion of the gas pipeline and cooling it there to a given temperature,
measuring pressure difference between at least two points of the coolable portion, and determining from a drop of pressure hydrate formation at the given temperature.

The invention relates to an examination process for the in situ determination of rate of feeding an inhibitor into a gas pipeline for preventing hydrate formation.

When transporting natural gas in a pipeline it is a problem that as the temperature of the gas decreases hydrates may form in the gas. During hydrate formation crystals are precipitated which can grow and agglomerate thereby forming hydrate plugs in the gas pipeline which hinder the gas transport thereafter. This problem is generally overcome on the one hand by heating the pipeline and on the other hand by feeding anti-hydrate compounds, typically thermodynamic inhibitors such as methanol, glycol or so called LDHI (Low Dosage Hydrate Inhibitor) type of inhibitors, into the pipeline that inhibit hydrate formation. The disadvantage of heating the pipeline is that it increases the cost of the transport of natural gas substantially. The use of methanol and other type of thermodynamic inhibitors is declining as these are strongly contaminating the environment, and require a substantially higher concentration than the LDHI type f inhibitors. The two most commonly used LDHIs are the kinetic inhibitors, which decrease the speed of hydrate formation, and the anti-agglomerate inhibitors, which prevent agglomeration of the hydrate particles. Hereinafter the LDHI type of inhibitors will be discussed, which will simply be referred to as inhibitors for the sake of simplicity.

Inhibitors of different type and composition are available of which the selection of the most suitable inhibitor and its feeding rate depends on the various parameters of the gas well, the gas pipeline and the gas to be transported. Such parameters are for example the depth of the gas well, its yield, the natural gas condensate content, the stratum water content, and the carbon-dioxide content of the natural gas, the length and material quality of the pipeline, the flow parameters, the expected temperature conditions within the pipeline, etc. The suitable inhibitor is generally chosen by taking a sample from the gas well-head, transporting the sample to a remote laboratory where different inhibitors are added to the sample and measurements are performed in order to determine the efficiency of the inhibitor. The disadvantage of this method is that the composition of the gas sample and the ratio of the gas phase and liquid phase may change during transportation due to chemical reactions taking place inside the sample. A further disadvantage is that the amount of the sample does not allow for investigating hydrate formation at an industrial scale which may substantially influence the usability of the measurement results.

It is an objective of the present invention to provide an examination system and process which overcome the problems associated with the prior art. In particular, it is an objective of the invention to provide an examination system and process, which allow for the in situ determination of the rate of feeding an inhibitor into a gas pipeline for preventing hydrate formation.

A further objective of the present invention is to develop a measuring system close to industrial dimensions, whereby the measurement results accurately reflect hydrate formation taking place inside gas pipelines used at gas wells.

These objectives are achieved by an examination process according to claim 1.

Certain advantageous embodiments of the invention are defined in the attached dependent claims.

Further details of the invention will be explained by way of exemplary embodiments with reference to the figures.

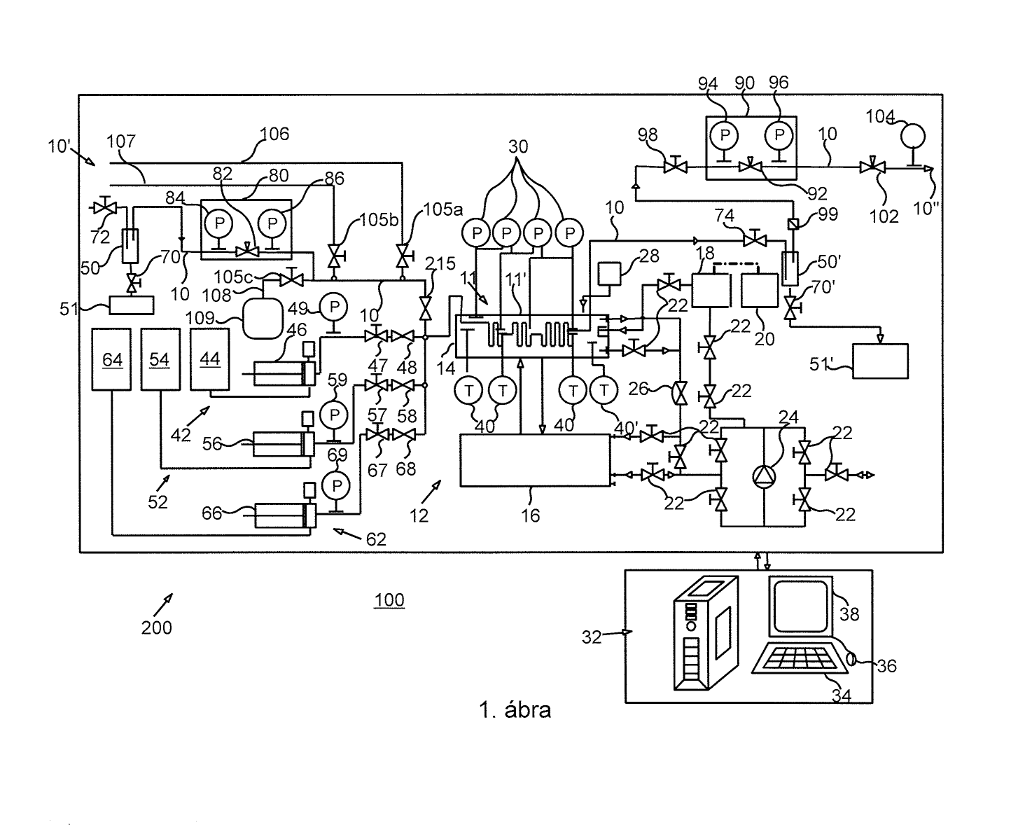

FIG. 1 is a schematic diagram of a preferred embodiment of an industrial scale measuring system forming part of a measuring system for performing the process according to the invention.

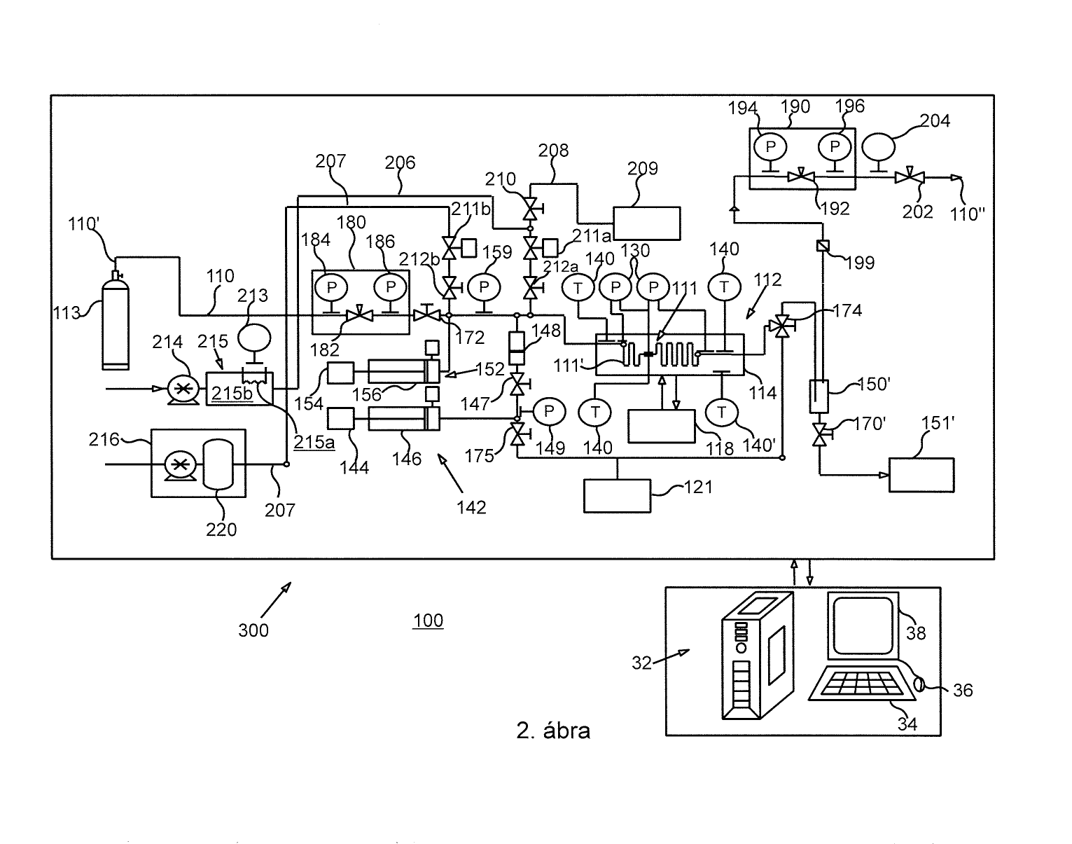

FIG. 2 is a schematic diagram of a preferred embodiment of a laboratory scale measuring system forming part of the measuring system according to the invention.

A preferred embodiment of an industrial scale measuring system 200 of an examination system 100 for performing the process according to the invention can be seen in FIG. 1. The examination system 100 may advantageously comprise a laboratory scale measuring system 300 as well. The main difference between the industrial scale measuring system 200 and the laboratory scale measuring system 300 is that the gas conduit 10 of the industrial scale measuring system 200 can be connected directly to the well-head of the gas well supplying the gas (natural gas) that is to be examined, whereby the examination may be performed in situ, i.e. on-site at the gas well. Furthermore, the dimensions of the industrial scale measuring system 200 are sufficiently close to the dimensions of the gas pipeline that is used to transport the gas from the gas well, in order to ensure that hydrodynamic and thermodynamic differences do not substantially influence the hydrate formation in the presence of the examined inhibitor. In contradistinction, the purpose of the optional laboratory scale measuring system 300 is to allow pre-measurements on substantially smaller amounts of gas in order to reduce the number of inhibitors that are to be examined, it is thereby possible to pre-screen in a fast and cost-efficient way which one or more inhibitors should be examined in the industrial scale measuring system 200.

The industrial scale measuring system 200 comprises a gas conduit 10 having a gas inlet 10′ which can be connected to a gas well-head. In the context of the invention the term gas well is understood to include any apparatus, formation or location serving as a gas source, for example a reservoir such as an underground reserve cave or artificial tank, and the term well-head is understood to refer to the gas outlet of such gas sources. The examination system 100 can be used in connection with any transport pipeline (either field conduit or pipes of a facility) or technology pipe in which hydrate formation may occur. Gas can be extracted from such gas pipes as well, in this case the point of extraction (typically a conduit branch) is regarded as the gas well-head. The gas pipeline is connected to the gas well-head for transporting the gas to a gas collection station or any other place of designation. The purpose of the invention is to determine the required rate of feeding a suitable hydrate inhibitor into such a gas pipeline. The gas transported through the gas pipeline remains inside the gas pipeline (between the input and output locations) for a given dwell time, thus the inhibitor and its feed-rate is generally considered adequate if it prevents hydrate formation during this dwell time, preferably during twice the dwell time.

The gas inlet 10′ of the gas conduit 10 is connectable to the well-head, preferably to the gate valve of the blind flange of the well-head assembly (Christmas-tree) or to an upper sample outlet of a conduit branch mounted on the gate valve in order to obtain dry gas free of liquid phase from the highest point of the gate valve. The gas inlet 10′ of the gas conduit 10 can be connected to the well-head either directly or indirectly (for example through an accessory part that is not part of the examination system 100). In the context of the present invention the gas inlet 10′ of the gas conduit 10 is regarded as being connectable to the gas well-head even if it is connectable indirectly, however, after connection continuous gas flow can be ensured from the gas well into the gas conduit 10.

The gas conduit 10 is preferably formed as a pulse line.

The industrial scale measuring system 200 comprises a heat exchanger 12 and the gas conduit 10 comprises a coolable portion 11 which is arranged in the heat exchanger 12. If necessary, the coolable portion 11 may also be heatable as well, thus the term coolable should not be interpreted in a limiting sense. The coolable portion 11 is preferably formed as a coil pipe 11′ the inner diameter of which is chosen so as to avoid capillary effects, in order to ensure better resemblance of the measuring conditions to the hydrodynamic conditions inside the gas pipeline that is connected to the gas well-head. In order to avoid capillary effects the inner diameter is at least 7 mm, more preferably at least 10 mm. In order to reduce the necessary amount of natural gas for the measurement the inner diameter of the coil pipe 11′ is preferably not greater than 20 mm. The length of the coil pipe 11′ is preferably at least 100 m in order to ensure sufficient heat exchange surface for cooling purposes, and is preferably not more than 200 m, however, longer coil pipes 11′ may be used for the simulation of particularly long gas conduit lines.

The material properties of the gas conduit 10 and in particular its coolable portion 11 is chosen in accordance with the material properties of the gas pipeline of the gas well in order to render the hydrodynamic and thermodynamic conditions more similar in this regard as well. Since the material of the gas pipelines used at gas wells is generally carbon steel, accordingly, preferably the gas conduit 10, in particular the coil pipe 11′ that is arranged within a heat exchange space 14 of the heat exchanger 12, is also made of carbon steel since it is preferred to have the same material properties as that of the gas transport pipeline in order to ensure that the same hydrodynamic conditions arise along the pipe wall. In case the material of the gas pipeline is acid-proof steel, this is preferably modeled by a coil pipe 11′ made of acid-proof steel.

The heat exchanger 12 preferably comprises a heat exchange space 14 wherein the coil pipe 11′ of the coolable portion 11 is arranged and which can be filled with a cooling medium. The heat exchanger 12 further comprises a tank 16 for discharging the cooling medium, a heat exchange unit 18 for cooling the cooling medium to a desired temperature and a deep freezer aggregator unit 20. The aforesaid components of the heat exchanger 12 may be connected to each other for example according to the basic circuit diagram illustrated in FIG. 1, through ball valves 22, and a pump 24 circulates the cooling liquid and helps to charge or discharge the heat exchange space 14 and the tank 16 of the heat exchanger 12. Preferably, the liquid level within the tank 16 can be monitored for example by liquid level sensors and/or through a sight glass 26 shown in FIG. 1.

The industrial scale measuring system 200 preferably comprises an air heater 28 in connection with the heat exchange space 14 of the heat exchanger 12 for reheating the gas transported in the coil pipe 11′ in case of hydrate plug formation therein as will be explained in more detail later on.

A pressure measuring device is arranged at minimum two locations but preferably at four locations along the coolable portion 11 in order to determine the pressure difference between the consecutive locations. According to the present invention the pressure measuring device comprises differential pressure gauges 30 and the pressure is measured at the inlet of the coil pipe 11′, at ¼ of its length, at half of its length and at its outlet, whereby drop of pressure can be measured at three different positions. In case of hydrate formation the location where the hydrate formation occurs can be deducted from the ensuing pressure drop.

The differential pressure gauges 30 are preferably in connection with a measurement data collection computer 32 in order to transmit the measurement data to the computer 32, which evaluates the received data with the help of a measurement controlling program. A data transmission connection between the differential pressure gauges 30 and the computer 32 can be ensured through wired or wireless connection (e.g. WiFi connection) as is known per se. In the context of the present invention the term computer is used in a broad sense including any hardware device that is suitable for collecting and processing data and, based thereon, controlling units of the examination system 300, for example desk top computer, laptop, tablet, smart phone, microcontroller, etc. The computer 32 preferably comprises one or more input devices (for example keyboard 34, mouse 36, etc.), one or more output devices (for example display 38, printer, etc.) and may comprise interfaces that can serve as both input and output devices (for example touch screen, CD/DVD reader/writer, etc.).

Preferably thermometers 40 are connected to the coolable portion 11 of the gas conduit 10 of the industrial scale measuring system 200 for measuring the temperature of the gas transported within the coil pipe 11′ at minimum two locations but preferably at three locations and a forth thermometer 40′ is provided for measuring the temperature of the cooling liquid. The thermometers 40, 40′ preferably transmit the measurement data to the computer 32.

The industrial scale measuring system 200 preferably further comprises an inhibitor feeding system 42 which is connected to the gas conduit 10 between the gas inlet 10′ and the coolable portion 11. The inhibitor feeding system 42 comprises an inhibitor tank 44 and a feeding pump 46, preferably an electric feeding pump connected therewith, which may be connected to the gas conduit 10 for example through ball valve 47 and check valve 48 as illustrated in FIG. 1. Preferably a pressure gauge 49 is provided between the feeding pump 46 and the ball valve 47.

The gas (natural gas) transported through the gas pipeline from the gas well comprises liquid phase stratum water and/or natural gas condensate in the amount characteristic of the gas well, the presence of which may influence the hydrate precipitation and the formation of hydrate plugs. The inventor has recognized that the amount of the stratum water and natural gas condensate that can be measured in the gas pipeline does not necessarily correspond to the proportions present in the gas conduit 10 of the industrial scale measuring system 200, for which reason it is preferred to separate the liquid phase (and any solid contaminants) from the examined gas by a separator 50, and feed stratum water and natural gas condensate in the proportions measurable in the transport pipeline into the gas conduit 10 upstream of the coolable portion 11. The industrial scale measuring system 200 preferably comprises for this purpose a stratum water feeding system 52 and a natural gas condensate feeding system 62 both of which are connected to the gas conduit 10 between the separator 50 and the coolable portion 11.

The stratum water feeding system 52 comprises a stratum water tank 54 and a feeding pump 56, preferably an electric feeding pump, connected therewith, which may be connected to the gas conduit 10 for example through a ball valve 57 and check valve 58 as illustrated in FIG. 1. Preferably a pressure gauge 59 is provided between the feeding pump 56 and the ball valve 57.

Similarly, the natural gas condensate feeding system 62 comprises a natural gas condensate tank 64 and a feeding pump 66, preferably an electric feeding pump, connected therewith, which may be connected to the gas conduit 10 for example through a ball valve 67 and check valve 68 as illustrated in FIG. 1. Preferably a pressure gauge 69 is provided between the feeding pump 66 and the ball valve 67.

The three feeding systems 42, 52, 62 can be formed as a single integrated system.

The separator 50 can be any kind of known device suitable for separating liquid. Preferably, a tank 51 is connected to the separator 50 through a ball valve 70 for collecting the separated liquid and solid contaminants. The gas inlet 10′ is preferably separated from the separator 50 by a ball valve 72.

Similarly, a separator 50′ can be applied downstream of the coolable portion 11 of the gas conduit 10 in order to separate the natural gas condensate, stratum water and inhibitor that has been fed into the gas stream. Preferably, a tank 51′ is also connected to the separator 50′ through a ball valve 70′. Preferably, the separator 50′ is connected to the portion of the gas conduit 10 exiting the heat exchanger 12 through a ball valve 74.

Preferably, a pressure regulator 80 is connected to the gas conduit 10 downstream of the separator 50 following the gas inlet 10′ in order to set the pressure of the transported gas for modeling the pressure conditions within the gas transport pipeline connected to the gas well. According to a preferred embodiment the pressure regulator 80 comprises a pressure reducing valve 82 and pressure gauges 84 and 86 connected upstream and downstream thereof, in order to visually present the entry and exit pressure values. The measurement data of the pressure gauges 84 and 86 can be transmitted to the computer 32, which may control the pressure reducing valve 82. The pressure regulator 80 is preferably connected to the coil pipe 11′ of the coolable portion 11 through a check valve 88.

A further pressure regulator 90 may be provided upstream of the gas outlet 10″ of the gas conduit 10 for setting the pressure of the gas exiting the gas conduit 10. According to a preferred embodiment the pressure regulator 90 comprises a pressure reducing valve 92 and pressure gauges 94 and 96 connected upstream and downstream thereof, in order to visually present the entry and exit pressure values. The pressure regulator 90 is preferably connected to the separator 50′ through a check valve 98.

The pressure regulator 90 is preferably followed by a choke valve 102 for setting the flow rate of the gas inside the gas conduit 10 which can be measured by a flowmeter 104. The flowmeter 104 may transmit measurement data to the computer 32 over a data transmission connection therewith. The pressure regulator 90, the choke valve 102 and the flowmeter 104 are preferably protected from any solid or liquid contaminants that may eventually pass the separator 50′ by a filter 99.

Preferably a conduit 106 for introducing hot water, a conduit 107 for introducing air and/or a conduit 108 for introducing nitrogen is connected to the gas conduit 10 of the industrial scale measuring system 200 between the gas inlet 10′ and the coolable portion 11 through ball valves 105a, 105b, 105c respectively. The hot water conduit 106 is advantageously connected to the local hot water network or it may be connected to the cold water network with the interposition of a water heater. The nitrogen is preferably introduced into the conduit 108 from a nitrogen tank 109.

The examination system 100 comprising the industrial scale measuring system 200 and optionally the laboratory scale measuring system 300 is preferably formed as a mobile station, whereby it can be transported to the location of the gas well, which is to be examined, and the measurements can be performed there. The examination system 100 is preferably provided in a container, thus the measuring apparatuses and accessories located in the container can be easily installed on the site of the examined well, whereby the measurements for preventing hydrate formation can be performed substantially faster and more efficiently, furthermore, the problems associated with the transport of the gas sample can be eliminated. Further advantage of the local (in situ) measurements is that the different stratum water and natural gas condensate content of the well flow can be easily taken into account by feeding the stratum water and natural gas condensate obtained from the well into the examination system 100. Since the efficiency of the examinations depend considerably on the number of measurements, hence the in situ performance of a high number of measurements can substantially reduce the time required to analyze a gas well; whereas the conventional measurements performed in laboratories inside remote buildings required months, the same measurements may be performed within a week with the help of the mobile station.

The inner space of the container is preferably monitored with a gas detector (not shown) in order to eliminate the risk of a gas explosion. The detector signals at 20% of LEL (Lower Explosive Limit), and shuts off the electric system at 40% of LEL.

The energy source of the mobile examination system 100 is preferably a current generator.

The industrial scale measuring system 200 is applied as follows.

Before starting the measurements the tank 16 of the heat exchanger 12 is filled with a cooling liquid, for example a 3:1 ratio mixture of glycol to distillated water, through the ball valve 22.

At the start of the measurement the heat exchange space 14 is filled with the cooling liquid from the tank 16 with the help of the pump 24. The cooling liquid is continuously circulated in the heat exchange space 14 by the deep freezer aggregator unit 20 which is thereby cooled to the desired temperature. The flow can be monitored through the sight glass 26.

The natural gas to be examined is obtained from the well, through the conduit branch of the well head, which is then transported through a pulse line to the gas inlet 10′ of the gas conduit 10 of the measuring system 200. The natural gas enters the industrial scale measuring system 200 through the ball valve 72 arranged at the gas inlet 10′. The liquid phase (practically stratum water and natural gas condensate) and solid contaminants are separated from the introduced natural gas with the help of the separator 50.

The required pressure for the measurement is then set by the pressure regulator 80.

In order to examine the formation of hydrates the conditions within the gas transport conduit have to be modeled. This is done by determining the amount of stratum water and natural gas condensate carried in the gas pipeline and a corresponding amount of stratum water and natural gas condensate is fed into the gas conduit 10 after the liquid phase has been separated but upstream of the entrance of the coolable portion 11. The amounts to be fed into the gas conduit 10 can be determined based on data of prior measurements (possibly conducted by third parties).

The feeding of the inhibitor, stratum water and natural gas condensate is ensured by the feeding systems 42, 52, 62 such that the inhibitor, stratum water and natural gas condensate are fed into the gas conduit 10 from the tank 44, 54, 64 of each feeding system 42, 52, 62 by the electric or pneumatic feeding pumps 46, 56, 66, respectively. The feed rate of the inhibitor is set in accordance with the examination (such an examination may be for example whether or not a given mass flow of a given inhibitor is sufficient to prevent hydrate formation at a given temperature). The stratum water and the natural gas condensate are fed into the natural gas at the amount necessary to obtain a composition ratio corresponding to the composition ratio within the natural gas transported inside the gas pipeline.

The gas containing the added inhibitor, stratum water and natural gas condensate is transported to the coolable portion 11 of the gas conduit 10, which is arranged inside the heat exchange space 14 of the heat exchanger 12, where the gas is cooled to the desired temperature with the cooling liquid. The drop of pressure of the natural gas within the heat exchange space 14 is measured at three locations by the differential pressure gauges 30 as explained earlier, and it is determined from the measured pressure drop whether or not a hydrate plug was formed along the measured portion, which hydrate plug obstructs the flow and thereby increases the pressure.

The temperature is measured continuously at four locations (at the inlet and outlet of the coil pipe 11, at ¼ of its length, furthermore the temperature of the cooling liquid is measured) by the thermometers 40 and 40′.

The resulting pressure drop values and temperature data are transmitted to the computer 32 collecting the measurement data, which then processes the data and preferably displays the data on the display 38. The computer 32 uses the data to determine the result of gas hydrate formation in connection with the gas obtained from the given gas well. The computer 32 preferably also monitors the measurement data of the pressure gauges 49, 59, 69 belonging to the feeding pumps 46, 56, 66, and may control the controllable elements thereof based on the measurement data.

The analysis performed by the examination system 100 helps in operating an inhibitor feeder installed permanently at the given well with the best efficiency. The most efficient industrial inhibitor can be selected and the amount of the inhibitor applied at the well can be reduced.

After examination, the natural gas is freed from the added stratum water, natural gas condensate and eventually any solid contaminants by the separator 50′ and the filter 99, and after having passed the flowmeter 104 it is conducted out from the container. The desired flow rate is set by the choke valve 102 having regard to the feed-back of the flowmeter 104.

After the system freezes, i.e. after a hydrate plug is formed, the coil pipe 11 arranged within the heat exchanger 12 has to be heated in order to eliminate the hydrate plug. The heating is performed by discharging the cooling medium from the heat exchange space 14 of the heat exchanger 12 into the tank 16, after which the coil pipe 11 is heated by the air heater 28 by blowing in air of approx. 40-50° C. until the plug is dissolved. The cooling medium is pumped back into the heat exchange space 14 from the tank 16, whereby substantially less time and energy is required for obtaining the necessary cooling temperature as compared to the case where the cooling medium is heated in the heat exchange space 14 for eliminating the hydrate plug.

The examination of the hydrate formation is performed by the industrial scale measuring system 200 for more than one type of inhibitors and/or more than one feed rate and/or by cooling the gas to more than one temperature. After each measurement the cooling medium is discharged into the tank 16, then the system is washed with hot water coming through the conduit 106, finally nitrogen is blown through the system, which is introduced from the tank 109 through the conduit 108. It is also possible to mix an inhibitor-neutral cleaning agent to the hot water.

The examination system 100 preferably also comprises a laboratory scale measuring system 300 in addition to the industrial scale measuring system 200, which allows for faster and less expensive pre-measurements performed with a smaller amount of gas in order to pre-screen the possible inhibitors.

The components of the laboratory scale measuring system 300 are similar to that of the industrial scale measuring system 200, for which reason the following description of the laboratory scale measuring system 300 concentrates mainly on the differences.

A gas inlet 110′ of a gas conduit 110 of the laboratory scale measuring system 300 transporting the examined gas (natural) is preferably connected to the gas well-head, or to a conduit branch attached thereto, or to a gas bottle 113 containing a gas sample from which stratum water and natural gas condensate have been separated. The gas bottle 113 can be preferably a commercially available bottle of standard size and pressure range.

The pressure of the gas introduced into the gas conduit 110 can be set to the value required for the examination by a pressure regulator 180. The pressure regulator 180 preferably comprises a pressure reducing valve 182 and pressure gauges 184 and 186 connected upstream and downstream thereof, which can be connected to the same computer 32 as the measuring devices of the industrial scale measuring system 200. It should be appreciated that preferably all measuring devices of the laboratory scale measuring system 300 may be connected to the same computer 32 or to another computer of similar function through wired or wireless connection allowing for data transmission.

The pressure regulator 182 is preferably connected to a coolable portion 111 of the gas conduit 110, that is formed as a measuring cell 111′ and is arranged within a heat exchange space 114 of a heat exchanger 112, through a two-way valve 172. Preferably cooling liquid cooled to a desired temperature is introduced into the heat exchange space 114 of the heat exchanger 112 from a liquid thermostat 118.

The dimensions of the measuring cell 111′ is chosen such as to allow for fast and cost efficient measurements, i.e. the gas and inhibitor are used in small amounts. Accordingly, the inner diameter of the measuring cell 111′ is between 3 mm and 5 mm, preferably approx. 4 mm; its outer diameter is approx. 6 mm; its length is preferably not more than 50 m, more preferably not more than 30 m, for example approx. 20 m. According to the preferred embodiment depicted in FIG. 2 the measuring cell 111′ is of double structure: it is made up of a 6 m long portion and a 12 m long portion, and pressure gauge and thermometer are arranged between the two portions.

The gas conduit 110, in particular the measuring cell 111′ arranged in the heat exchange space 114 of the heat exchanger 112 is preferably made of carbon-steel, or acid-proof steel in case the gas pipeline is made of acid-proof steel as explained in connection with the industrial scale measuring system 200.

A pressure measuring device is arranged at minimum two locations but preferably at three locations along the coolable portion 111 in order to determine the pressure difference between the consecutive locations. According to the present invention the pressure measuring instrument comprises differential pressure gauges 130 and the pressure is measured at the inlet of the coil pipe 111′, at ⅓ of its length, and at its outlet, whereby pressure drop can be measured at two different positions. In case of hydrate formation the location where the hydrate formation occurs can be deducted from the ensuing drop of pressure.

Preferably, thermometers 140 are connected to the coolable portion 111 of the gas conduit 110 for measuring the temperature of the gas transported within the measuring cell 111′ at minimum two locations but preferably at three locations and a forth thermometer 140′ is provided for measuring the temperature of the cooling liquid. The thermometers 140, 140′ preferably transmit the measurement data to the computer 32.

The laboratory scale measuring system 300 preferably further comprises an inhibitor feeding system 142, which is connected to the gas conduit 110 upstream of the coolable portion 111. The inhibitor feeding system 142 comprises an inhibitor tank 144 and a feeding pump 146, preferably an electric feeding pump connected therewith, which may be connected to the gas conduit 110 for example through a two-way valve 147 and a floating piston cell 148 as illustrated in FIG. 2. The floating piston cell 148 serves to inject the hydrate inhibitor into the gas. Preferably a pressure gauge 149 is provided between the feeding pump 146 and the ball valve 147.

The liquid phase and any solid contaminants have been preferably separated in advance from the gas sample used in the laboratory scale measuring system 300, or these are separated in a separator installed at the gas well. Stratum water and natural gas condensate are fed into the gas conduit 110 upstream of the coolable portion 111 in the amount characteristic for the gas well. The natural gas condensate is preferably mixed with the inhibitor, and injected into the gas conduit 110 by the inhibitor feeding system 142, while a separate stratum water feeding system 152 is used for adding the stratum water. It is also conceivable to provide a separate feeding system for the natural gas condensate. The stratum water feeding system 152 comprises a stratum water tank 154 and a feeding pump 156, preferably an electric feeding pump. Preferably a pressure gauge 159 is provided between the feeding pump 156 and the inlet of the inhibitor feeding system 142.

The measurement data of the pressure gauges 149, 159 are preferably also transmitted to the computer 32, which may optionally control the feeding systems 142, 152 using this data.

Preferably, a separator 150′ is applied downstream of the coolable portion 111 of the gas conduit 110 for the deposition of the liquids precipitated from the gas flow, primarily for the separation of the natural gas condensate, stratum water and inhibitor that has been fed into the gas stream. Preferably, a tank 151′ is also connected to the separator 150′ through a two-way valve 170′. Preferably, the separator 150′ is connected to the portion of the gas conduit 110 exiting the heat exchanger 112 through a three-way valve 174. The three-way valve 174 allows for discharging into the tank 121 a washing liquid that is passed through the gas conduit 110 when it is being washed. The tank 121 is preferably connected to the inhibitor feeding system 142 through a valve 175 as can be seen in FIG. 2.

A pressure regulator 190 is preferably provided upstream of the gas outlet 110″ of the gas conduit 110 for setting the pressure of the gas exiting the gas conduit 110. According to a preferred embodiment the pressure regulator 190 comprises a pressure reducing valve 192 and pressure gauges 194 and 196 connected upstream and downstream thereof, in order to visually present the entry and exit pressure values. The measurement data of the pressure gauges 194, 196 may be transmitted to the computer 32. The pressure regulator 190 is preferably connected to the separator 150′ through a filter 199.

The pressure regulator 190 is preferably followed by flowmeter (mass flow meter) 204 and a choke valve 202 for setting the flow rate of the gas inside the gas conduit 110. The flowmeter 204, just like the other measuring devices, may transmit measurement data to the computer 32 through a data transmission connection therewith. The flowmeter 204 is preferably protected from any solid or liquid contaminants that may eventually pass the separator 150′ by a filter 199.

Preferably a conduit 206 for introducing hot water, a conduit 207 for introducing air and a conduit 208 for introducing chemical agents is connected to the gas conduit 110 of the laboratory scale measuring system 300 upstream of the coolable portion 111 through subsequent magnetic valves 211a, 211b and two-way valves 212a, 212b, respectively, as can be seen in FIG. 2. The hot water conduit 106 is advantageously connected to the local hot water system or it may be connected to the cold water system with the interposition of a water heater. The nitrogen is preferably introduced into the conduit 108 from a nitrogen tank 109. The magnetic valves 211a, 211b are preferably also controlled by the computer 32, and compressed air and washing water are introduced into the gas conduit 110 through these valves 211a, 211b when the gas conduit 110 is being cleaned.

The hot water conduit 206 is preferably connected to the local cold water network. The cold water is pumped to a water heater 215 connected to the conduit 206 by a pump 214. The water heater 215 heats the cold water by a heating body 215a and stores the hot water in a tank 215b. The water temperature can be set by a temperature regulator 213 manually or optionally by the computer 32. Another possibility is to connect the hot water conduit 206 to the hot water network.

Preferably, the chemical agent is introduced into the conduit 208 from a tank 209, and the conduit 208 can be closed off by a separate valve 210.

Preferably a compressor 216 is connected to the air introducing conduit 207 for venting and drying the gas conduit 110 between the measurements. The compressor 216 can be any known device, for example a device providing maximum 6-8 bar pressure. The compressor 216 typically comprises an air tank 220.

The laboratory scale measuring system 300 is applied as follows.

The examined natural gas is introduced into the gas conduit 110. The natural gas passes the pressure regulator 180 before entering the coolable portion 111 of the gas conduit 110 that is arranged in the heat exchanger 112. The valves 212a and 212b are kept closed during the measurement.

The examined gas is introduced into the coolable portion 111 through the valve 172. The hydrate inhibitor needs to be mixed to the examined gas in advance, which can be accomplished by the feeding pump 142 in accordance with the pre-set feeding rate. The inhibitor is stored in the tank 144 together with the required amount of natural gas condensate before starting the measurement.

The stratum water must also be ensured for the measurements, which can be fed from the tank 154 by the feeding system 152.

The heat exchange space 114 of the heat exchanger 112 is cooled to the extent required for the measurement by the cooling liquid provided by the thermostat 118. The measuring cell 111′ of the coolable portion 111 of the gas conduit 110, made up of two portions, is arranged inside the heat exchange space 114.

The pressure drop is measured between three locations within the measuring cell 111 by the differential pressure gauges 130 as explained earlier, and the measurement data is collected by the computer 32 for the purpose of determining hydrate formation. The temperature is measured at the inlet and outlet of the measuring cell 111′ and between the two portions of the measuring cell 111′, furthermore, the temperature of the cooling medium is also measured inside the heat exchange space 114, and the data is transmitted to the computer 32.

Downstream of the coolable portion 111 the gas can be conducted, through the three-way valve 174, to the separator 150′ and then to the filter 199 in order to separate the stratum water, natural gas condensate and solid contaminants. The gas flows from the filter 199 to the pressure regulator 190 from where it flows to the flowmeter 204 and the choke valve 202. The choke valve 202 has a high resolution fine regulator with which the desired flow parameters can be set, which are measured by the flowmeter 204.

The examined gas exits the measuring system 300 through the gas outlet 110″, and exits the container.

Hydrate formation is also examined by the laboratory scale measuring system 300 in different quantities

The examination of the hydrate formation is performed by the laboratory scale measuring system 300 for an inhibitor added in different quantities and/or more than one type of inhibitors and/or at least at two given temperatures. Typically more than one type of commercially available inhibitors are examined in order to measure only those types in the industrial scale measuring system 200 which could be efficient according to the laboratory measurements.

After each measurement the gas conduit 110 is washed with hot water and chemicals, and high pressure air is blown through the system. The water required for the washing phase is obtained from the water heater 215, which is connected to the pump 214 that is connected to the cold water network. The water heated by the heating body 215a and stored in the tank 215b of the water heater 215 is introduced into the gas conduit 110 through the conduit 206.

In case of hydrate formation the chemicals are added to the hot water from the tank 209 through the conduit 209 and the valve 210.

The washing liquid enters the measuring cell 111′ through the magnetic valve 211a and the valve 212a. During washing the valve 172 must be closed and the three-way valve 174 is set such that the washing liquid flows into the tank 121. The valve 212b must be closed during the washing phase.

The drying phase following the washing phase is preferably performed by the air introduced through conduit 207, the pressure of which is set by the compressor 216. The air can be introduced into the measuring cell 111′ through the magnetic valve 211b and the valve 212b. When blowing-off the air the three-way valve 174 is set to its measurement state, in which state the air exits the system through the natural gas outlet and is lead outside of the container.

The construction of the laboratory scale measuring system 300, serving to examine the formation of hydrates and the performance of hydrate inhibiting preparations, is such that it can be easily arranged within a container and it can be transported without risk of failure. The devices and accessory components are also sufficiently secured.

Various modifications to the above disclosed embodiments will be apparent to a person skilled in the art without departing from the scope of protection determined by the attached claims.

1. Examination process for the in situ determination of rate of feeding an inhibitor into a gas pipeline for preventing hydrate formation comprising the steps of:
taking gas in situ from a gas well through a gas conduit having an inlet,
feeding the inhibitor into the gas conduit,
transporting the gas comprising the inhibitor to a coolable portion of the gas conduit and cooling it there to a given temperature,
measuring pressure difference between at least two locations of the coolable portion, and determining from a drop of pressure hydrate formation at the given temperature.

2. The process according to claim 1, characterized by performing the examination of the hydrate formation for an inhibitor added in at least two different quantities and/or at least two types of inhibitors and/or at least at two given temperatures.

3. The process according to claim 1, characterized by washing the coolable portion of the gas conduit with hot water and blowing air or nitrogen there through between consecutive measurements.

4. The process according to claim 1, characterized by providing a coil pipe as the coolable portion of the gas conduit, the coil pipe having an inner diameter chosen such as to avoid capillary effects, the inner diameter being preferably at least 7 mm, more preferably at least 10 mm.

5. The process according to claim 1, characterized by providing a coil pipe of at least 100 m length as the coolable portion of the gas conduit.

6. The process according to claim 1, characterized by measuring the temperature of the coolable portion in at least two locations.

7. The process according to claim 6, characterized by that the measurement result for the pressure difference is corrected with the measured temperatures.

8. The process according to claim 1, characterized by separating the liquid phase and solid contaminants from the gas with a separator prior to feeding the inhibitor.

9. The process according to claim 1, characterized by determining the amount of stratum water and natural gas condensate carried in the gas pipeline, after having separated the liquid phase feeding stratum water and natural gas condensate to the gas inside the gas conduit in accordance with the determined amounts prior to introducing the gas into the coolable portion.

10. The process according to claim 1, characterized by cooling the coolable portion by introducing a cooling medium into a heat exchange space of a heat exchanger and in case of hydrate formation discharging the cooling medium into a tank, and heating the coolable portion by an air heater connected to the heat exchange space until the hydrate plug is eliminated.

11. The process according to claim 1, characterized by setting a desired mass flow of the gas inside the gas conduit by a choke valve connected to the gas conduit.

12. The process according to claim 1, characterized by performing a pre-measurement in a laboratory scale measuring system for pre-screening the inhibitors that are to be examined, by:
taking gas from a gas well,
introducing the gas into a gas conduit,
feeding the inhibitor that is to be pre-screened into the gas conduit,
transporting the gas comprising the inhibitor to a maximum 20 m long coolable portion of the gas conduit and cooling it there to a given temperature,
measuring pressure difference between at least two locations of the coolable portion, and determining from a drop of pressure hydrate formation at the given temperature.

13. The process according to claim 12, characterized by providing a coil pipe as the coolable portion of the gas conduit of the laboratory scale measuring system, the coil pipe having an inner diameter of 3 to 5 mm, preferably of 4 mm.

14. The process according to claim 12, characterized by performing the examination of the hydrate formation in the laboratory scale measuring system for an inhibitor added in at least two different quantities and/or at least two types of inhibitors and/or at least at two given temperatures.

15. The process according to claim 14, characterized by washing the coolable portion of the gas conduit of the laboratory scale measuring system with hot water and blowing air there through between consecutive measurements.

16. The process according to claim 12, characterized by separating the liquid phase and eventually solid contaminants from the gas taken from the gas well with a separator.

17. The process according to claim 12, characterized by determining the amount of stratum water and natural gas condensate carried in the gas pipeline, and after having separated the liquid phase, feeding stratum water and natural gas condensate into the gas in accordance with the determined amounts prior to introducing the gas into the coolable portion of the laboratory scale measuring system.

18. The process according to claim 12, characterized by taking the gas from a gas inlet of the gas conduit of the laboratory scale measuring system, which gas conduit is connectable to a well-head of the gas well.

19. The process according to claim 12, characterized by introducing the gas from the gas well into a gas bottle and feeding the gas into the gas of the laboratory scale measuring system conduit therefrom.
